(19) United States
(12) Patent Application Publication
(10) Pub. No.: US 2023/0232829 A1
(43) Pub. Date: Jul. 27, 2023

(54) HIGH-LOAD HALOXYFOP ESTER COMPOSITIONS

(71) Applicant: Dow Argo Sciences LLC, Indianapolis, IN (US)

(72) Inventors: Ricardo Acosta Amado, Indianapolis, IN (US); Nathan Vitorazzi de Castro, Campinas (BR); Hongyoung Jeon, Zionsville, IN (US)

(21) Appl. No.: 16/959,927

(22) PCT Filed: Jan. 3, 2019
(86) PCT No.: PCT/US19/12117

§ 371 Date: Jul. 2, 2020

Related U.S. Application Data
(60) Provisional application No. 62/613,497, filed on Jan. 4, 2018.

(51) Int. Cl. A01N 43/40; A01N 25/04; A01P 13/00

(52) U.S. Cl. CPC A01N 43/40; A01N 25/04; A01P 13/00

(57) ABSTRACT

Provided herein are high-load emulsifiable concentrate compositions containing at least 875 g/L haloxyfop ester, a solvent, and a surfactant. The concentrate compositions leave less than 3.9 weight percent residue upon pouring at 5° C.

### CROSS-REFERENCE TO RELATED APPLICATION

This application claims the benefit of U.S. Provisional Application Ser. No. 62/613,497 filed Jan. 4, 2018, which is expressly incorporated by reference in its entirety herein.

### FIELD

This disclosure includes high-load haloxyfop ester compositions having reduced viscosity and/or improved pourability and their methods of use. Such compositions are useful, for example, when used at low temperatures.

### BACKGROUND

The development and use of high-load, liquid agricultural chemical formulations are important innovations that reduce the cost of pest control through lower packaging costs, increased transportation efficiency, reduction in container disposal costs, and decreased use of solvent in the formulation (decrease in both costs and potential environmental impact). Development of these formulations, however, is not without challenges such as low active ingredient solubility, high viscosity (particularly at cold temperatures), insufficient storage stability and tank-mixing problems. Haloxyfop, such as (R)-Haloxyfop-methyl is currently sold as a 520 grams acid equivalent per liter (gae/L) emulsifiable concentrate formulation, but additional value could be found through the savings and impacts mentioned above if the concentration could be substantially increased.

Recently registered a high-load product containing 900 gae/L of (R)-haloxyfop-methyl exhibit a viscosity greater than 11 pascal-second (Pa·s) at −5° C. which greatly exceeds the viscosity of the current 520 gae/L products on the market 0.16 Pa·s). Such a viscosity increase could make handling and applying the product challenging when used at cold temperatures. High-load (R)-haloxyfop-methyl formulations with lower viscosity would improve usability at low temperatures.

Therefore a need exists for high-load haloxyfop formulations with lower viscosity and/or pourability to improve the ability to use such formulations.

### SUMMARY

Provided herein are high-load, emulsifiable concentrate compositions containing at least about 875 gae/L of an haloxyfop ester, one or more solvents, and one or more surfactants. The concentrate compositions leave less than 3.9 weight percent residue upon pouring at 5° C.

### DETAILED DESCRIPTION

### I. Active Ingredient

As used herein, haloxyfop ester many be understood to include all haloxyfop esters, such as the ester having the following structure:

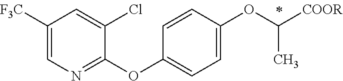

wherein R is a C₁-C₆ alkyl group and the chiral carbon (marked with *) may be enriched in the (R)-enantiomer or may be a racemic mixture containing equal amounts of (R)- and (S)-enantiomers.

For example, (R)-haloxyfop-methyl (1) has the following structure:

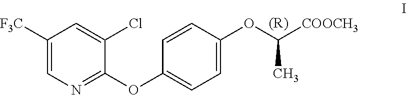

The compound of Formula I can also be identified by the name methyl (R)-2-[4-(3-chloro-5-trifluoromethyl-2-pyridyloxy)phenoxy]propanoate and its properties and uses have been described in “The Pesticide Manual,” 12^{th} Edition (2000), pg. 499-501, which is incorporated herein by reference. The compound of Formula (I) has a chiral carbon atom which exists predominately in the (R)-configuration (which is the major enantiomer in commercial products). Exemplary uses of the compound of Formula I include controlling undesirable vegetation, including mainly grass weeds, in multiple non-crop and cropping situations.

The described high-load (R)-haloxyfop-methyl emulsifiable concentrate (EC) compositions include at least about 900 grams acid equivalent per liter (gae/L) of (R)-haloxyfop-methyl (1). At least about 900 grams acid equivalent per liter (gae/L) of (R)-haloxyfop-methyl as used herein means at least 875 gae/L, at least 880 gae/L, at least 885 gae/L, at least 890 gae/L, at least 895 gae/L, at least 900 gae/L, at least 905 gae/L, at least 910 gae/L, at least 915 gae/L, at least 920 gae/L, or at least 925 gae/L of (R)-haloxyfop-methyl (I).

### III. Solvents

The high-load, herbicidal, emulsifiable concentrate (EC) compositions containing (R)-haloxyfop-methyl (1), also contain one or more solvents, and one or more surfactants.

Solvents for use in the high-load, emulsifiable concentrates may include the following:
a) propylene glycol ethers of Formula I:

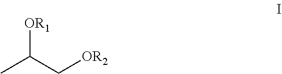

wherein R₁ is a H, methyl or acetyl, and R₂ is a C₁-C₃ alkyl or 2-methoxypropan-1-yl. Compounds of Formula I include propylene glycol monomethyl ether acetate (available as Dowanol™ PMA or Eastmanh™ PM Acetate), 1-propoxypropan-2-ol (available as Dowanol™ PnP or Huntsman PP), dipropylene glycol dimethyl ether (available as Proglyde™ DMM), and methoxyisopropanol (available as Dowanol™ PM, Eastman™ PM, and Huntsman PM).
b) ethylene glycol ethers of Formula II:

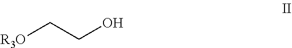

wherein R₃ is a C₁-C₆ alkyl. Compounds of Formula II include 2-propoxyethanol (available as Propyl Cellosolve™, Eastman™ EP, and Huntsman EP) and 2-(hexyloxy) ethanol (available as hexyl Cellosolve™).
c) fatty acid methyl esters of Formula III:

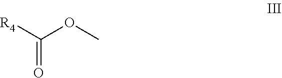

wherein R₄ is a C₅, C₇, or a C₉ linear alkyl group. Fatty acid methyl esters of Formula III, and mixtures thereof, include those available as Steposol® C-25 and Agnique ME 610.
d) propanoic acid esters of Formula IV:

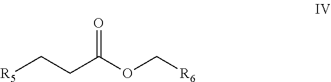

wherein R₅ is H or OCH₂CH₃, and R₆ is a C₁-C₄ alkyl. Compounds of Formula IV include the propyl, butyl, and pentyl esters of propanoic acid (R₅=H; R₆=C₂-C₄ alkyl), and the ethyl ester of 3-ethoxypropanoic acid (R₅=OCH₂CH₃; R₆=CH₃; known as UCAR™ Ester EEP), which are all available as UCAR™ solvents from Dow).
e) dialkylbenzenes of Formula V:

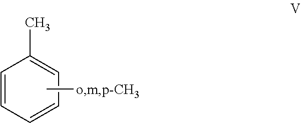

wherein the dialkylbenzenes of Formula V include xylenes, such as the o-, m- and p-xylenes, and mixtures thereof.
f) alkyl lactates: Suitable alkyl lactates may include aliphatic C₁-C₁₈-alkyl lactates (in particular C₆-C₁₀-alkyl lactates), which may be linear or branched. Examples are cyclohexyl lactate, 2-ethylhexyl lactate, 2-methylcyclohexyl lactate, heptyl lactate, octyl lactate, or mixtures of these. Especially preferred is 2-ethylhexyl lactate. The alkyl lactates can be present in the form of D- and or L-lactates, with the L-lactates being preferred.
g) Alcohols: alcohols that come into consideration are preferably C₂-C₁₂ alkanols such as ethanol, propanol, hexanol, octanol and dodecanol. The alcohols may be straight-chain or branched, for example 2-ethylhexanol and isotridecanol. Could be present in the form of diols or triols, for example ethylene glycol, propylene glycol, dipropylene glycol and 2-methyl-2,4-pentanediol. Cyclic alcohols, preferably cyciopentanol and cyclohexanol, can likewise be used according to the various aspects.

In addition, mixtures of any of the compounds and solvents described herein may provide an acceptable solvent for the described emulsifiable concentrates.

The high-load, herbicidal, emulsifiable concentrates may include from about 10 weight percent (wt %) to about 20 wt % of the solvent or mixture of solvents. In some embodiments, the high-load, herbicidal, emulsifiable concentrates may include from about 10 wt % to about 18 wt %, from about 10 wt % to about 16 wt %, from about 10 wt % to about 15 wt %, from about 11 wt % to about 15 wt %, or from about 12 wt % to about 14 wt % of the solvent or mixture of solvents relative to the total composition.

### IV. Surfactants

The high-load, herbicidal emulsifiable concentrates containing (R)-haloxyfop-methyl (1) require the use of at least one emulsifying surfactant. Suitable emulsifying surfactants may be selected from nonionic surfactants and anionic surfactants or commercial blends of them.

Suitable nonionic surfactants may include the following surfactant groups and their associated products including polyoxyalkylene fatty alcohol ethers such as, for example, Tensiofix™ 96DB08 and Tensiofix™ 97DB03 (Ajinomoto OmniChem), polyoxyalkylene alkyl ethers such as, for example, Termulta® 203 (Huntsman), alkyl alcohol ethoxylates such as, for example, Makon® TD-18 (Stepan), tributylphenol ethoxylates such as, for example, Sapogenat® T 080 (Clariant), ethoxylated castor oils such as, for example. Toximul® 8242 (Stepan)

Tensiofix™ 96DB08 contains a polyoxyalkylene fatty alcohol ether surfactant (e.g., a fatty alcohol alkoxylate or a polyalkylene glycol fatty alkyl ether) which is an EO-PO copolymer ether prepared from a fatty alcohol, ethylene oxide (oxirane) and propylene oxide (methyl oxirane). The fatty alcohol may include one or more of a C₂-C₁₅ linear or branched, fully saturated, carbon chain, and the EO (ethylene oxide) and PO (propylene oxide) units may be in a random or block arrangement in the copolymer chain. Examples of fatty alcohols may include, for example, lauryl alcohol (e.g., 1-dodecanol), tridecyl alcohol (e.g., I-tridecanol) myristyl alcohol (e.g., 1-tetradecanol), pentadecyl alcohol (e.g., 1-pentadecanol), and mixtures thereof.

Termul® 203 contains a polyoxyalkylene alkyl ether surfactant (e.g., an alcohol alkoxylate or a polyalkylene glycol alkyl ether) which is an EO-PO polymer prepared from butyl alcohol, ethylene oxide (oxirane) and propylene oxide (methyl oxirane), and is known in the Chemical Abstracts chemical registry system as: oxirane, methyl-, polymer with oxirane, monobutyl ether (CAS number 9038-95-3). Termulm® 203 has an HLB (Hydrophile-Lipophile Balance) value of 17.5. The HLB value is an empirical expression for the relationship of the hydrophilic (“water-loving”) and hydrophobic (“water-hating”) groups of a surfactant.

Makont® TD-18 contains a tridecyl alcohol ethoxylate surfactant that has an average of 18 EO units per molecule and has an HLB value of 16.

Sapogenate® T 080 is a tri-sec-butylphenol polyglycol ether with an average of 8 moles of ethoxylation.

Toximula® 8242 is a castor oil ethoxylated with an average of 40 moles of ethoxylation.

Suitable anionic surfactants include, for example, sulfosuccinates such as, for example, Aerosol® OT-S(Solvay), calcium alkylbenzene sulfonates optionally in a liquid solvent carrier such as, for example, Ninate® 60E (Stepan) also available from other suppliers, for example Nansa® EVM 70/2E (Innospec), Agnique® ABS 60-C EH (BASF).

Ninatex® 60E contains a 60 wt % calcium dodecylbenzene sulfonate.solution in 2-ethylhexanol.

Aerosol® OT-S(Solvay) is dioctyl sodium sulfosuccinate also available from other suppliers, for example Dow Chemical as Triton™ (GR-7M.

Also suitable commercially available anionic and nonionic surfactant blends such as, for example. Atlox™ AL 3307 (Croda).

The amount of the at least one emulsifying surfactant included in the high-load herbicidal emulsifiable concentrates may range from about 1 wt % to about 20 wt %, from about 5 wt % to about 15 wt %, from about 5 wt % to about 13 wt %, from about 5 wt % to about 10 wt %, from about 5 wt % to about 8 wt %, with respect to the total composition.

The high-load, herbicidal emulsifiable concentrate compositions described herein can include a solvent comprised of a compound of Formula H, wherein R₃ is a linear propyl group and a nonionic surfactant that is a polyoxyalkylene fatty alcohol ether.

The high-load, herbicidal emulsifiable concentrate compositions described herein can include a solvent comprised of a compound of Formula I, wherein R₁ is H and R₂ is a C₁-C₃ alkyl group, and a nonionic surfactant that is a polyoxyalkylene fatty alcohol ether.

The high-load, herbicidal emulsifiable concentrate compositions described herein can include a solvent comprised of a compound of Formula I, wherein R₁ is H and R₂ is a C₁-C₃ alkyl group, a nonionic surfactant that is a polyoxyalkylene alky ether, and an anionic surfactant that is a calcium alkylbenzene sulfonate.

The high-load, herbicidal emulsifiable concentrate compositions described herein can include a solvent comprised of a compound of Formula I, wherein R₁ is H and R₂ is 2-nethoxypropan-1-yl, and a nonionic surfactant that is a polyoxyalkylene fatty alcohol ether.

The high-load, herbicidal emulsifiable concentrate compositions described herein can include a solvent comprised of a compound of Formula I, wherein Rₜ is H and R₂ is a C₁-C₃ alkyl group, and a nonionic surfactant that is a polyoxyalkylene fatty alcohol ether.

The high-load, herbicidal emulsifiable concentrate compositions described herein can include a solvent comprised of a compound of Formula I, wherein R₁ is acetyl and R₂ is a C₁-C₃ alkyl group, a nonionic surfactant that is a polyoxyalkylene alkyl ether, and an anionic surfactant that is a calcium alkylbenzene sulfonate.

The high-load, herbicidal emulsifiable concentrate compositions described herein can include a solvent comprised of one or more dialkylbenzene compounds that include one or more than one of the group consisting of o-xylene, m-xylene and p-xylene, a nonionic surfactant that is a polyoxyalkylene fatty alcohol ether, and an anionic surfactant that is a calcium alkylbenzene sulfonate.

The high-load, herbicidal emulsifiable concentrate compositions described herein can include a solvent comprised of a compound of Formula IV, wherein R₅ is H and R₆ is a C₁-C₄ alkyl group or an ethyl group, and the nonionic surfactants include at least one polyoxyalkylene fatty alcohol ether and a tridecyl alcohol ethoxylate.

The high-load, herbicidal emulsifiable concentrate compositions described herein can include a solvent comprised of a compound of Formula IV, wherein R₅ is OCH₂CH₃ and R₆ is a C₁-C₄ alkyl group or a methyl group, and the nonionic surfactants include at least one polyoxyalkylene fatty alcohol ether and a tridecyl alcohol ethoxylate.

The high-load, herbicidal emulsifiable concentrate compositions described herein can include a solvent comprised of a compound of Formula IV, wherein R₅ is H and R₆ is a C₁-C₄ alkyl group or a linera propyl group, and the nonionic surfactants include at least one polyoxyalkylene fatty alcohol ether and a tridecyl alcohol ethoxylate.

The high-load, herbicidal emulsifiable concentrate compositions described herein can include a solvent comprised of a compound of Formula IV, wherein R₅ is H and R₆ is a C₁-C₄ alkyl group or a linera butyl group, and the nonionic surfactants include at least one polyoxyalkylene fatty alcohol ether and a tridecyl alcohol ethoxylate.

The high-load, herbicidal emulsifiable concentrate compositions described herein can include solvents comprised of a compound of Formula IV, wherein R₅ is H and R₆ is a C₁-C₄ alkyl group and a compound of Formula II, wherein R: is a C₁-C₆ alkyl, and the surfactants comprises at least one polyoxyalkylene fatty alcohol ether and an anionic and nonionic surfactant blend.

The high-load, herbicidal emulsifiable concentrate compositions described herein can include solvents comprised of a compound of Formula IV, wherein R₅ is H and R₆ is a C₁-C₄ alkyl group and a C₂-C₁₂ straight-chain or branched-chain alcohol, and the surfactants comprises at least one polyoxyalkylene fatty alcohol ether and an anionic and nonionic surfactant blend.

The high-load, herbicidal emulsifiable concentrate compositions described herein can include solvents comprised of a compound of Formula IV, wherein R₅ is H and R₄ is a C₁-C₄ alkyl group and an aliphatic C₁-C₁₈ alkyl lactate linear or branched in the form of D- and or L-lactate, and the surfactants comprises at least one polyoxyalkylene fatty alcohol ether and an anionic and nonionic surfactant blend.

The high-load, herbicidal emulsifiable concentrate compositions described herein can include solvents comprised of a compound of Formula IV, wherein R₅ is H and R₆ is a C₁-C₄ alkyl group and an aliphatic C₁-Cis alkyl lactate linear or branched in the form of D- and or L-lactate, and the surfactants comprises at least one polyoxyalkylene fatty alcohol ether and an alkyl sodium sulfosuccinate.

The high-load, herbicidal emulsifiable concentrate compositions described herein can include a solvent comprised of a compound of Formula IV, wherein R₅ is H and R₆ is a C₁-C₄ alkyl group, and the surfactants comprises at least one polyoxyalkylene fatty alcohol ether, an alkyl sodium sulfosuccinate and a tributylphenol ethoxylate.

### IV. Viscosity

The viscosity of the high-load, herbicidal emulsifiable concentrate compositions described herein is an important physical property to measure in order to evaluate the utility of the compositions for their intended use. Important aspects of the compositions related to viscosity include low temperature viscosity such as, for example, viscosity at temperatures of less than about −5° C., less than about 0° C., less than about 5° C., less than about 10° C., or less than about 20° C. In addition, the viscosity of the concentrate compositions may impact pourability, emulsion formation, emulsion stickiness or adhesion to the walls and/or filters of the application equipment and emulsion stability. The viscosity of a particular liquid composition can be dependent on the relative amounts and types of the ingredients in the composition, and the temperature at which the viscosity is measured.

Because of the large amount of active ingredient in high-load compositions, in some aspects, there may be less room for other ingredients and therefore fewer options available to control high viscosity that may be inherent in such compositions. However, in some aspects, viscosity at a temperature of −5° C. may be as little as 6.7 pascal-second (Pa·s) or less, as little as 5 Pa·s or less, as little as 4 Pa·s or less, as little as 3 Pa·s or less, or as little as 2 Pa·s or less.

Measured viscosities for the high-load, herbicidal emulsifiable concentrates described herein, when measured with a TA Instruments HR-2 Discovery rheometer operated at a shear rate of 100 sec⁻¹ and equipped with a stainless steel, 60 mm, 2 degree cone spindle, may be less than about 11 Pascal-seconds (Pa·sec) at about −5° C., less than about 5.2 Pascal-seconds (Pa·sec) at about 0° C., less than about 2.5 Pascal-seconds (Pa·sec) at about 5° C., less than about 1.3 Pascal-seconds (Pa·sec) at about 10° C., or less than about 0.4 Pascal-seconds (Pa·sec) at about 20° C.

### V. Pourability

As discussed previously, improved pourability of high-load haloxyfop formulations can improve the ability to use such formulations in the field. In various aspects, pourability in some aspects, at a temperature of 5° C., pourability may be as little as 3.9 weight percent residue or less, 3 weight percent residue or less, or 2 weight percent residue or less.

To investigate how efficiently the high-load emulsifiable concentrates of (R)-haloxyfop methyl ester can be handled at various temperatures, a series of samples were tested for pourability at 5° C. using CIPAC MT 148 method. Following the method, a sample of a concentrate was allowed to stand for a defined time at 5° C. and the amount remaining in a test cylinder after a standardized pouring procedure (60 second pour at 45 degree angle) followed by a water wash were determined. Residue after pouring (RAP) and residue after rinsing (RAR) values were obtained as weight percent of the initial sample. The results are shown in Example 3.

### VI. Additional Ingredients

The high-load, herbicidal emulsifiable concentrate compositions containing (R)-haloxyfop-methyl (1) described herein can be applied in conjunction with one or more other herbicides to control a wider variety of undesirable vegetation. When used in conjunction with other herbicides, the composition can be formulated with the other herbicide or herbicides, tank-mixed with the other herbicide or herbicides, or applied sequentially with the other herbicide or herbicides. Some of the herbicides that can be employed in conjunction with the compositions and methods described herein include, but are not limited to: 4-CPA, 4-CPB, 4-CPP, 3,4-DA, 3,4-DB, 2,4-DEB, 2,4-DEP, 3,4-DP, 2,3,6-TBA, 2,4,5-T, 2,4,5-TB, acetochlor, acifluorfen, aclonifen, alachlor, allidochlor, alloxydim, alorac, ametridione, ametryn, amibuzin, amicarbazone, amidosulfuron, aminocyclopyrachlor, aminopyralid, amiprofos-methyl, amitrole, ammonium sulfamate, anilofos, anisuron, asulam, atraton, atrazine, azafenidin, azimsulfuron, aziprotryne, barban, BCPC, beflubutamid, benazolin, bencarbazone, benfluralin, benfuresate, bensulfuron-methyl, bensulide, benthiocarb, bentazon-sodium, benzadox, benzfendizone, benzipram, benzobicyclon, benzofenap, benzofluor, benzoylprop, benzthiazuron, bialaphos, bicyclopyrone, bifenox, bilanafos, bispyribac-sodium, borax, bromacil, bromobonil, brmmobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole, chlorprocarb, carfentrazone-ethyl, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorsulfuron, chlorthal, chlorthiamid, cinidon-ethyl, cinmethylin, cinosulfuron, cisanilide, clethodim, cliodinate, clodinafop-propargyl, clofop, clomazone, clomeprop, cloprop, cloproxydim, cloransulam-methyl, CMA, copper sulfate, CPMF, CPPC, credazine, cresol, cumyluron, cyanatryn, cyanazine, cycloate, cyclopyrimorate, cyclosulfamuron, cycloxydim, cycluron, cyhalofop-butyl, cyperquat, cyprazine, cyprazole, cypromid, dalapon, dazomet, delachlor, desmedipham, desmetryn, di-allate, dichlobenil, dichloralurea, dichlormate, dichlorprop, dichlorprop-P, diclofop-methyl, diclosulam, diethamquat, diethatyl, difenopenten, difenoxuron, difenzoquat, diflufenican, diflufenzopyr, dimefuron, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, DMPA, DNOC. DSMA, EBEP, eglinazine, endothal, epronaz, EPTC, erbon, esprocarb, ethalfluralin, ethametsulfuron, ethidimuron, ethiolate, ethofumesate, ethoxyfen, ethoxysulfuron, etinofen, etnipromid, etobenzanid. EXD, fenasulam, fenoprop, fenoxaprop, fenoxaprop-P-ethyl, fenoxaprop-P-ethyl+isoxadifen-ethyl, fenoxasulfone, fenteracol, fenthiaprop, fentrazamide, fenuron, flamprop, flamprop-M, flazasulfuron, florasulam, fluazifop, fluazifop-P-butyl, fluazolate, flucarbazone, flucetosulfuron, fluchloralin, flufenacet, flufenican, flufenpyr-ethyl, flumetsulam, flumezin, flumiclorac-pentyl, flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, flurochloridone, flurtamone, fluthiacet, fomesafen, foramsulfuron, fosamine, fumiclorac, furyloxyfen, glufosinate salts and esters, glufosinate-ammonium, glufosinate-P-ammonium, glyphosate salts and esters, halosafen, halosulfuron-methyl, haloxydine, haloxyfop-methyl, haloxyfop-P-methyl, hexachloroacetone, hexaflurate, hexazinone, imazamethabenz, imazamox, imazapic, imazapyr, imazaquin, imazethapyr, imazosulfuron, indanofan, indaziflam, iodobonil, iodomethane, iodosulfuron, iodosulfuron-ethyl-sodium, iofensulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lenacil, linuron, MAA, MAMA, mecoprop, mecoprop-P, medinoterb, mefenacet, mefluidide, mesoprazine, mesosulfuron, mesotrione, metam, metamifop, metamitron, metazachlor, metazosulfuron, metflurazon, methabenzthiazuron, methalpropalin, methazole, methiobencarb, methiozolin, methiuron, methometon, methoprotryne, methyl isothiocyanate, methyldymron, metobenzuron, metobromuron, metolachlor, metosulam, metoxuron, metribuzin, metsulfuron, metsulfuron-methyl, molinate, monalide, monisouron, monochloroacetic acid, monolinuron, monuron, morfamquat. MSMA, naproanilide, napropamide, napropamide-M, naptalam, neburon, nicosulfuron, nipyraclofen, nitralin, nitrofen, nitrofluorfen, norflurazon, noruron, orbencarb, orthosulfamurnm, oryzalin, oxadiargyl, oxadiazon, oxapyrazon, oxasulfuron, oxaziclomefone, oxyfluorfen, paraflufen-ethyl, parafluron, paraquat, pebulate, pelargonic acid, pendimethalin, penoxsulam, pentachlorophenol, pentanochlor, pentoxazone, perfluidone, pethoxamid, phenisopham, phenmedipham, phenmedipham-ethyl, phenobenzuron, phenylmercury acetate, picloram, picolinafen, pinoxaden, piperophos, potassium arsenite, potassium azide, potassium cyanate, pretilachlor, primisulfuron-methyl, procyazine, prodiamine, profluazol, profluralin, profoxydim, proglinazine, prohexadione-calcium, prometon, prometryn, pronamide, propachlor, propanil, propaquizafop, propazine, propham, propisochlor, propoxycarbazone, propyrisulfuron, propyzamide, prosulfalin, prosulfocarb, prosulfuon, proxan, prynachlor, pydanon, pyraclonil, pyraflufen-ethyl, pyrasulfotole, pyrazogyl, pyrazolynate, pyrazosulfuron-ethyl, pyrazoxyfen, pyribenzoxim, pyributicarb, pyricltor, pyridafol, pyridate, pyriftalid, pyriminobac, pyrimisulfan, pyrithiobac-sodium, pyroxasulfone, pyroxsulam, quinclorac, quinmerac, quinoclamine, quinonamid, quizalofop, quizalofop-P-ethyl, rhodethanil, rimsulfuron, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfometuron, sulfosate, sulfosulfuron, sulfuric acid, suiglycapin, swep, SYN-523, TCA, tebutam, tebuthiuron, tefuryltrione, tembotrione, tepraloxydim, terbacil, terbucarb, terbuchlor, terbumeton, terbuthylazine, terbutryn, tetrafluron, thenylchlor, thiazafluron, thiazopyr, thidiazimin, thidiazuron, thiencarbazone-methyl, thifensulfuron, thifensulfuron-methyl, thiobencarb, tiocarbazil, tioclorim, topramezone, tratkoxydim, triafamone, tri-allate, triasulfuron, triaziflam, tribenuron, tribenuron-methyl, tricamba, tridiphane, trietazine, trifloxysulfuron, trifluralin, triflusulfuron, trifop, trifopsime, trihydroxytriazine, trimeturon, tripropindan, tritac, tritosulfuron, vernolate, xylachlor and salts, esters, optically active isomers and mixtures thereof.

In some embodiments, the compositions described herein are employed in combination with one or more plant growth regulators, such as 2,3,5-tri-iodobenzoic acid, IAA, IBA, naphthaleneacetamide, α-naphthaleneacetic acids, benzyladenine, 4-hydroxyphenethyl alcohol, kinetin, zeatin, endothal, pentachlorophenol, thidiazuron, tribufos, aviglycine, ethephon, maleic hydrazide, gibberellins, gibberellic acid, abscisic acid, ancymidol, fosamine, glyphosine, isopyrimol, jasmonic acid, maleic hydrazide, mepiquat, morphactins, dichiorflurenol, flurprimidol, mefluidide, paclobutrazol, tetcyclacis, uniconazole, brassinolide, brassinolide-ethyl, cycloheximide, ethylene, methasulfocarb, prohexadione, triapenthenol, and trinexapac-ethyl. In some embodiments, the plant growth regulator is mixed with the halauxifen to cause a preferentially advantageous effect on plants.

The compositions provided herein can further include one or more agriculturally acceptable adjuvant or carrier. Such mixtures can be designed for application directly to weeds or their locus or can be concentrates or formulations that are normally diluted with additional carriers and adjuvants before application. The adjuvants or carriers can be solids, such as, for example, dusts, granules, water-dispersible granules, or wettable powders, or liquids, such as, for example, emulsifiable concentrates, solutions, emulsions or suspensions. Additionally, the adjuvants or carriers can also be provided as a pre-mix or tank-mixed.

Suitable agricultural adjuvants and carriers include, but are not limited to, crop oil concentrate; nonylphenol ethoxylate; benzylcocoalkyldimethyl quaternary ammonium salt; blend of petroleum hydrocarbon, alkyl esters, organic acid, and anionic surfactant; C₉-C₁₁ alkylpolyglycoside: phosphated alcohol ethoxylate: natural primary alcohol (C₁₂-C₁₆) ethoxylate; di-sec-butylphenol EO-PO block copolymer; polysiloxane-methyl cap; nonylphenol ethoxylate+urea ammonium nitrate: emulsified methylated seed oil; tridecyl alcohol (synthetic) ethoxylate (8EO); tallow amine ethoxylate (15 EO); PEG(400) dioleate-99.

Examples of liquid carriers that can be used in the compositions and methods described herein include water and organic solvents. Examples of useful organic solvents include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like. Specific organic solvents include, but are not limited to toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide, liquid fertilizers and the like. Water is useful as a carrier for the dilution of concentrates.

Suitable solid carriers include but are not limited to talc, pyrophyllite clay, silica, attapulgus clay, kaolin clay, kieselguhr, chalk, diatomaceous earth, lime, calcium carbonate, bentonite clay, Fuller's earth, cottonseed hulls, wheat flour, soybean flour, pumice, wood flour, walnut shell flour, lignin, cellulose, and the like.

The compositions described herein may further include one or more surface-active agents. Such surface-active agents can be used in both solid and liquid compositions, and can be designed to be diluted with a carrier before application. The surface-active agents can be anionic, cationic or nonionic in character and can be employed as emulsifying agents, wetting agents, suspending agents, or for other purposes. Surfactants which may also be used in the present formulations are described, inter alia, in McCutcheon's Detergents and Emulsifiers Annual, MC Publishing Corp.: Ridgewood, N.J., 1998 and in Encyclopedia of Surfactants, Vol. I-III, Chemical Publishing Co.: New York, 1980-81. Surface-active agents include, but are not limited to salts of alkyl sulfates, such as diethanolammonium lauryl sulfate; alkylarylsulfonate salts, such as calciumdodecylbenzenesulfonate; alkylphenol-alkylene oxide addition products, such as nonylphenol-Cis ethoxylate; alcohol-alkylene oxide addition products, such as tridecyl alcohol-C₁₆ ethoxylate; soaps, such as sodium stearate; alkylnaphthalene-sulfonate salts, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable or seed oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, e.g., methyl esters. These materials, such as vegetable or seed oils and their esters, can be used interchangeably as an agricultural adjuvant, as a liquid carrier or as a surface active agent.

Other additives useful in the compositions provided herein include, but are not limited to, compatibilizing agents, antifoam agents, sequestering agents, neutralizing agents and buffers, corrosion inhibitors, dyes, odorants, spreading agents, penetration aids, sticking agents, dispersing agents, thickening agents, freezing point depressants, antimicrobial agents, and the like. The compositions may also contain other compatible components, for example, other herbicides, plant growth regulators, fungicides, insecticides, and the like and can be formulated with liquid fertilizers or solid, particulate fertilizer carriers such as ammonium nitrate, urea and the like.

The concentration of active ingredients in the compositions described herein is generally from 0.0005 to 98 percent by weight. Additionally, concentrations from 0.0006 to 90 percent by weight can be used. In compositions designed to be employed as concentrates, the active ingredients can be present in a concentration from 0.1 to 98 weight percent or from 0.5 to 90 weight percent. Such compositions can be diluted with an inert carrier, such as, for example, water, before application. The diluted compositions usually applied to vegetation or the soil adjacent thereto can contain from 0.0006 to 15.0 weight percent active ingredient or from 0.001 to 10.0 weight percent active ingredient.

The following Examples are presented to illustrate various aspects of the compositions and methods described herein and should not be construed as limitations to the claims.

### EXAMPLES

### Example 1. Preparation of High-Load (R)-Haloxyfop-Methyl Compositions (900 Gae/L) with the Solvents and Surfactants Listed in Table 1

(R)-haloxyfop-methyl ester technical grade material (about 97% purity) was diluted in each of the solvents listed in Table 1 and then one or more surfactants were added to provide the compositions 1-39 and Comparative Example A listed in Table 1. Comparative Example A was prepared using information from patent application AU 2014203147 (A1). Block copolymers should be heated until liquid to facilitate addition. Agitation of each sample was provided by using a simple agitator impeller for homogenization. The resulting samples were found to be translucent, brown, homogeneous solutions with commercially acceptable emulsion performance in a wide range of water hardness when tested following the CIPAC MT 36.3 method.

TABLE 1A
Samples of 900 gae/l (R)-Halosyfop-Methyl Ester Formulations with the
Solvents and Surfactants Shown (amounts in % weight)

| | % Weight | | | | | | | |
|---|---|---|---|---|---|---|---|---|
| Sample # | 1 | 2 | 3 | 4 | 5 | 6 | 7 | 8 |
| (R-Haloxyfop methyl ester | 77.05 | 77.25 | 76.87 | 76.96 | 77.13 | 77.21 | 77.14 | 77.23 |
| technical | | | | | | | | |
| Tensiofix 96DB08 | | | 10.00 | | 10.00 | | 10.00 | |
| Termul 203 | 7.00 | | | 7.00 | | 7.00 | | 7.00 |
| Ninate 60E (60 wt %) | 3.00 | | | 3.00 | | 3.00 | | 3.00 |
| Toximul 8242 | | 10.00 | | | | | | |
| Propyl Cellosolve ™ | 12.95 | | | | | | | |
| Agnique ME 610 | | 12.75 | | | | | | |
| Dowanol PM | | | 13.13 | 13.04 | | | | |
| Proglyde ™ DMM | | | | | 12.87 | 12.79 | | |
| Dowanol PnP | | | | | | | 12.86 | 12.77 |

TABLE 1B
Samples of 900 gae/l (R)-Haloxyfop-Methyl Ester Formulations with the
Solvents and Surfactants Shown (amounts in % weight)

| | % Weight | | | | | | | | |
|---|---|---|---|---|---|---|---|---|---|
| Sample # | 9 | 10 | 11 | 12 | 13 | 14 | 15 | 16 | 17 |
| (R-Haloxyfop methyl ester | 77.53 | 77.54 | 77.40 | 76.48 | 76.96 | 77.41 | 77.11 | 77.20 | 77.34 |
| technical | | | | | | | | | |
| Tensiofix 96DB08 | 7.90 | | 10.00 | | | 10.00 | 10.00 | | |
| Termul 203 | | 7.00 | | 7.00 | 7.90 | | | 7.00 | |
| Ninate 60E (60 wt %) | 3.00 | 3.00 | | 3.00 | 3.00 | | | 3.00 | |
| Toximul 8242 | | | | | | | | | 10.00 |
| Solvesso 100 | 12.47 | 12.46 | | | | | | | |
| Dowanol ™ PuB | | | 12.60 | 12.52 | | | | | |
| Dowanol ™ PMA | | | | | 13.59 | 13.49 | | | |
| Butyl Cellosolve ™ | | | | | | | 12.89 | 12.80 | |
| Stepan C-42 | | | | | | | | | 12.66 |

TABLE 1C
Samples of 900 gae/l (R)-Haloxyfop-Methyl Ester Formulations with the
Solvents and Surfactants Shown (amounts in % weight)

| | % Weight | | | | | | | | |
|---|---|---|---|---|---|---|---|---|---|
| Sample # | 18 | 19 | 20 | 21 | 22 | 23 | 24 | 25 | 26 |
| (R)Haloxyfop methyl ester | 77.22 | 77.23 | 77.73 | 77.03 | 76.21 | 76.31 | 76.08 | 76.18 | 75.76 |
| technical | | | | | | | | | |
| Tensiofix 96DB08 | 7.00 | | | 7.00 | 10.00 | | 10.00 | | 10.00 |
| Termul 203 | | 7.00 | | | | 7.00 | | 7.00 | |
| Nisate 60E (60 wt %) | 3.00 | 3.00 | | 3.00 | | 3.00 | | 3.00 | |
| Toximul 8242 | | | 10.00 | | | | | | |
| Aromatic 150 ND | 12.78 | 12.77 | | | | | | | |
| Agnique ME 12-70 | | | 12.27 | | | | | | |
| Cyclohexanone | | | | 12.97 | | | | | |
| Methyl Carbitol ™ | | | | | 13.79 | 13.69 | | | |
| Acetophenone | | | | | | | 13.92 | 13.82 | |
| Dimethyl Adipate | | | | | | | | | 14.24 |

TABLE 1D
Samples of 900 gae/l (R)-Haloxyfop-Methyl Ester Formulations with the
Solvents and Surfactants Shown (amounts in % weight)

| | % Weight | | | | | | | | |
|---|---|---|---|---|---|---|---|---|---|
| Sample # | 27 | 28 | 29 | 30 | 31 | 32 | 33 | 34 | 35 |
| (R-Haloxyfop methyl ester | 75.86 | 76.54 | 76.63 | 76.79 | 76.88 | 77.16 | 77.17 | 77.67 | 76.95 |
| technical | | | | | | | | | |
| Tensiofix 96DB08 | | 10.00 | | 10.00 | | 7.00 | | 5.30 | 5.06 |
| Termul 203 | 7.00 | | 7.00 | | 7.00 | | 7.00 | | |
| Ninate 60E (60 wt %) | 3.00 | | 3.00 | | 3.00 | 3.00 | 3.00 | | |
| Makon TD 18 | | | | | | | | 1.40 | 1.34 |
| Tensiofix 97DB03 | | | | | | | | 3.30 | 3.15 |
| Toximul 8242 | | | | | | | | | |
| Dimethyl Adipate | 14.14 | | | | | | | | |
| Carbitol ™ Solvent | | 13.46 | 13.37 | | | | | | |
| Hexyl Cellosolve ™ | | | | 13.21 | 13.12 | | | | |
| Xylene | | | | | | 12.84 | 12.83 | | |
| UCAR n-propyl propionate | | | | | | | | 12.33 | |
| UCAR Ester EEP | | | | | | | | | 12.50 |

TABLE 1E
Samples of 900 gae/l (R)-Haloxyfop-Methyl Ester Formulations with
the Solvents and Surfactants Shown (amounts in % weight)

| | % Weight | | | | |
|---|---|---|---|---|---|
| | | | | | Comparative |
| Sample # | 36 | 37 | 38 | 39 | Example A |
| (R )-Haloxyfop methyl ester | 77.79 | 77.77 | 77.73 | 76.96 | 78.62 |
| technical | | | | | |
| Tensiofix 96DB08 | 5.06 | 5.23 | | 10.00 | |
| MakonTD 18 | 1.34 | 1.38 | | | |
| Tensiofix 97DB03 | 3.15 | 3.25 | | | |
| Toximul 8242 | | | 10.00 | | |
| UCAR n-butyl propionate | 12.66 | | | | |
| UCAR n-pentyl propionate | 12.37 | 12.37 | | | |
| Stepan C-40 | | | 12.27 | | |
| Propy Cellosolve ™ | | | | 13.04 | |
| Termul 203 | | | | | 4.83 |
| Ninate 60E (60 wt %) | | | | | 2.07 |
| Carbitol ™ Solvent | | | | | 14.48 |

TABLE 1F
Samples of 900 gae/l (R)-Haloxyfop-Methyl Ester Formulations
with the Solvents and Surfactants Shown (amounts in % weight)

| | % Weight | | | | |
|---|---|---|---|---|---|
| Sample # | 40 | 41 | 42 | 43 | 44 |
| (R)-Haloxyfop methyl ester | 76.16 | 76.21 | 76.30 | 76.85 | 77.09 |
| techaical | | | | | |
| Tensiofix 96DB08 | 1.82 | 3.75 | 6.00 | 1.30 | 1.30 |
| Aflox AL 3307 | 5.46 | | | 4.00 | 4.00 |
| Aerosol OT-S | | 3.50 | 2.00 | | |
| Sapogenat T 080 | | 2.75 | | | |
| Purasolv EHL | 2.13 | | 2.00 | | |
| Hexyl Cellosolve ™ | | | | 4.70 | |
| 2-ethyl-1-hexanol | | | | | 4.70 |
| UCAR n-pentyl propionate | 13.84 | 13.79 | 13.70 | 13.15 | 12.91 |

### Example 2. Determination of the Viscosity of the High-Load (R)-Haloxyfop-Methyl Compositions Prepared in Example 1

Viscosity values for the compositions shown in Table 1 were determined and are presented in Table 2. Viscosities were measured with TA Instruments HR-2 Discovery rheometer equipped with a stainless steel, 60 mm, 2 degree cone and are reported in Pascale-seconds at temperatures of −5° C., 0° C., 5° C., 10° C., 20° C., 30° C., and 40° C.

TABLE 2
Viscosity Determination of the 900 gae/l (R)-Haloxyfop-Methyl Ester Samples
Prepared in Table 1 (reported in Pascale-seconds)

| | Viscosity, Pascale-seconds | | | | | | |
|---|---|---|---|---|---|---|---|
| Sample # | @ −5° C. | @ 0° C. | @ 5° C. | @ 10° C. | @ 20° C. | @ 30° C. | @ 40° C. |
| 15 | 12.646 | 5.855 | 2.772 | 1.400 | 0.432 | 0.168 | 0.078 |
| 1 | 10.865 | 5.211 | 2.549 | 1.323 | 0.426 | 0.170 | 0.081 |
| Comparative | 11.115 | 5.151 | 2.440 | 1.237 | 0.383 | 0.149 | 0.070 |
| Example A | | | | | | | |
| 7 | 10.490 | 4.860 | 2.316 | 1.172 | 0.365 | 0.143 | 0.082 |
| 2 | 10.154 | 4.798 | 2.341 | 1.210 | 0.389 | 0.155 | 0.074 |
| 13 | 10.179 | 4.726 | 2.254 | 1.146 | 0.360 | 0.143 | 0.068 |
| 5 | 9.477 | 4.506 | 2.197 | 1.139 | 0.368 | 0.148 | 0.071 |
| 4 | 8.735 | 4.191 | 2.063 | 1.077 | 0.352 | 0.143 | 0.069 |
| 39 | 8.156 | 3.928 | 1.934 | 1.011 | 0.330 | 0.143 | 0.065 |
| 33 | 6.643 | 3.224 | 1.606 | 0.855 | 0.300 | 0.127 | 0.098 |
| 3 | 6.097 | 2.991 | 1.507 | 0.803 | 0.272 | 0.114 | 0.057 |
| 37 | 5.560 | 2.903 | 1.488 | 0.508 | 0.285 | 0.123 | 0.060 |
| 35 | 5.610 | 2.818 | 1.459 | 0.798 | 0.286 | 0.124 | 0.062 |
| 32 | 4.880 | 2.357 | 1.180 | 0.626 | 0.213 | 0.092 | 0.047 |
| 36 | 4.620 | 2.324 | 1.210 | 0.670 | 0.244 | 0.107 | 0.054 |
| 34 | 4.459 | 2.266 | 1.185 | 0.656 | 0.239 | 0.108 | 0.055 |
| 41 | 4.091 | 2.223 | 1.159 | 0.630 | 0.219 | 0.094 | 0.047 |
| 42 | 3.570 | 1.854 | 0.982 | 0.544 | 0.197 | 0.086 | 0.044 |
| 40 | 2.576 | 1.403 | 0.758 | 0.426 | 0.159 | 0.073 | 0.039 |
| 44 | 1.880 | 1.071 | 0.587 | 0.335 | 0.128 | 0.059 | 0.031 |
| 43 | 1.697 | 0.986 | 0.553 | 0.320 | 0.125 | 0.058 | 0.031 |

### Example 3. Determination of the Pourability (CIPAC MT 148) at 5° C. of Various High-Load (R)-Haloxyfop-Methyl-Compositions Prepared in Example 1

To investigate how well the high-load formulations of (R)-haloxyfop methyl ester could be handled at low temperature, a series of samples were tested for pourability at 5° C. using the CIPAC MT 148 method. Briefly, this method involves measuring the amount of material remaining in a container after a standardized pouring procedure (60 seconds of pour time at a 45 degree angle). The container was then rinsed with water and the amount of material then remaining in the container after a second pour is determined.

TABLE 3
Residue After Pouring (RAP) and Residue After Rinsing (RAR) values
obtained from pourability test of high-load (R)-haloxyfop-methyl compositions and
comparison to the Comparative Example A¹ - Using CIPAC MT 148 at 5° C.

| | | Wt. % Less RAP | | Wt. % Less RAR |
|---|---|---|---|---|
| | Wt % | vs. Comparative | Wt % RAR | vs. Comparative |
| Sample | RAP | Example A | (water rinse) | Example A |
| 1 | 4.58 | | 1.12 | |
| 2 | 4.2 | | 1.22 | |
| Comparative | 4.12 | — | 1.09 | — |
| Example A | | | | |
| 33 | 4.04 | 1.94% | 1.06 | 2.75% |
| 7 | 3.99 | 3.16% | 0.66 | 39.45% |
| 4 | 3.9 | 5.34% | 1.28 | −17.43% |
| 5 | 3.78 | 8.25% | 1.18 | −8.26% |
| 13 | 3.69 | 10.44% | 0.96 | 11.93% |
| 39 | 3.64 | 11.65% | 0.92 | 15.60% |
| 35 | 3.36 | 18.45% | 1.04 | 4.59% |
| 32 | 3.19 | 22.57% | 0.6 | 44.95% |
| 3 | 3.08 | 25.24% | 1.02 | 6.42% |
| 36 | 2.99 | 27.43% | 0.67 | 38.53% |
| 37 | 2.84 | 31.07% | 0.38 | 65.14% |
| 34 | 2.29 | 44.42% | 0.61 | 44.04% |
| 41 | 2.10 | 49.03% | 0.25 | 77.06% |
| 40 | 1.78 | 56.80% | 0.13 | 88.07% |
| 42 | 1.61 | 60.92% | 0.10 | 90.83% |
| 44 | 1.25 | 69.66% | 0.09 | 91.74% |
| 43 | 1.25 | 69.66% | 0.10 | 90.83% |

The present invention is not limited in scope by the various embodiments or aspects disclosed herein which are intended as illustrations of a few aspects and any embodiments which are functionally equivalent are within the scope of this invention. Various modifications of the compositions and methods in addition to those shown and described herein will become apparent to those skilled in the art and are intended to fall within the scope of the appended claims. Further, while only certain representative combinations of the composition components and method steps disclosed herein are specifically discussed in the embodiments above, other combinations of the composition components and method steps will become apparent to those skilled in the art and also are intended to fall within the scope of the appended claims. Thus a combination of components or method steps may be explicitly mentioned herein; however, other combinations of components and method steps are included, even though not explicitly stated. The term comprising and variations thereof as used herein is used synonymously with the term including and variations thereof and are open, non-limiting terms.

What is claimed is:

1. An emulsifiable concentrate comprising:
(a) at least about 875 g/L of an haloxyfop ester on a grams acid equivalent per litre (gae/L) basis;
(b) one or more solvents; and
(c) one or more surfactants;
wherein the concentrate leaves less than 3.9 weight percent residue upon pouring at 5° C.

2. The emulsifiable concentrate of claim 1, wherein the concentration of the haloxyfop ester is at least about 900 g/L on a gram acid equivalent per litre basis.

3. The emulsifiable concentrate of claim 1, wherein the haloxyfop ester is (R)-haloxyfop-methyl.

4. The emulsifiable concentrate of claim 1, wherein the one or more solvents are selected from the group including propylene glycol ethers, ethylene glycol ethers, fatty acid methyl esters, propanoic acid esters, lactates, alcohols and dialkylbenzenes.

5. The emulsifiable concentrate of claim 1, wherein the one or more surfactants are selected from the group consisting of anionic surfactants and nonionic surfactants or mixtures thereof.

6. The emulsifiable concentrate of claim 5, wherein the anionic surfactants are selected from the group consisting of linear calcium alkylbenzene sulfonates and alkyl sodium sulfosuccinates.

7. The emulsifiable concentrate of claim 5, wherein the nonionic surfactants are selected from the group consisting of polyoxyalkylene fatty alcohol ethers, polyoxyalkylene alkyl ethers, tributylphenol ethoxylates, and tridecyl alcohol ethoxylates.

8. The emulsifiable concentrate of claim 1, wherein the one or more solvents are selected from the group consisting of:
i. the propylene glycol ether of Formula I 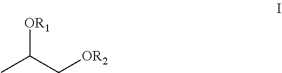
wherein R₁ is a H, methyl or acetyl, and R₂ is a C₁-C₃ alkyl or 2-methoxypropan-1-yl;
ii. the ethylene glycol ether of Formula II 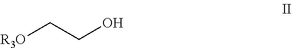
wherein R₃ is a C₁-C₆ alkyl;
iii. the fatty acid methyl ester of Formula III 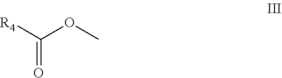
wherein R₄ is a C₅-C₁₁ alkyl;
iv. the propanoic acid ester of Formula IV 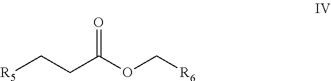
wherein R₅ is H or OCH₂CH₃, and R₆ is a C₁-C₄ alkyl; and
v. the dialkylbenzenes of Formula V 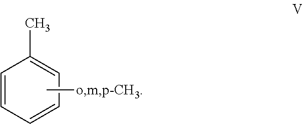
vi. aliphatic C₁-C₁₈-alkyl lactates linear or branched in the form of D- and or L-lactates
vii. C₂-C₁₂ straight-chain or branched-chain alcohols.

9. The emulsifiable concentrate of claim 8, wherein the solvent comprises a compound of Formula II, wherein R₃ is a C₁-C₆ alkyl, and the nonionic surfactant is a polyoxyalkylene fatty alcohol ether.

10. The emulsifiable concentrate of claim 8, wherein the solvent comprises a compound of Formula I, wherein R₁ is H and R₂ is a C₁-C₃ alkyl group, and the nonionic surfactant is a polyoxyalkylene fatty alcohol ether.

11. The emulsifiable concentrate of claim 8, wherein the solvent comprises a compound of Formula I, wherein R₁ is H and R₂ is a C₁-C₃ alkyl group, the nonionic surfactant is a polyoxyalkylene alkyl ether, and the anionic surfactant is a calcium alkylbenezene sulfonate.

12. The emulsifiable concentrate of claim 8, wherein the solvent comprises a compound of Formula I, wherein R₁ is H and R₂ is 2-methoxypropan-1-yl, and the nonionic surfactant is a polyoxyalkylene fatty alcohol ether.

13. The emulsifiable concentrate of claim 8, wherein the solvent comprises a compound of Formula I, wherein R₁ is H and R₂ is a C₁-C₃ alkyl, and the nonionic surfactant is a polyoxyalkylene fatty alcohol ether.

14. The emulsifiable concentrate of claim 8, wherein the solvent comprises a compound of Formula I, wherein R₁ is acetyl and R₂ is a C₁-C₃ alkyl group, the nonionic surfactant is a polyoxyalkylene alkyl ether, and the anionic surfactant is a calcium alkylbenezene sulfonate.

15. The emulsifiable concentrate of claim 8, wherein the solvent comprises one or more dialkylbenzene compounds, the nonionic surfactant is a polyoxyalkylene fatty alcohol ether, and the anionic surfactant is a calcium alkylbenezene sulfonate.

16. The emulsifiable concentrate of any claim 8, wherein the solvent comprises a compound of Formula IV, wherein R₅ is H and R₆ is a C₁-C₄ alkyl group, and the nonionic surfactants include at least one polyoxyalkylene fatty alcohol ether and a tridecyl alcohol ethoxylate.

17. The emulsifiable concentrate of claim 8, wherein the solvent comprises a compound of Formula IV, wherein R₅ is OCH₂CH₃ and R₆ is a C₁-C₄ alkyl group, and the nonionic surfactants include at least one polyoxyalkylene fatty alcohol ether and a tridecyl alcohol ethoxylate.

18. The emulsifiable concentrate of claim 8, wherein the solvents comprises a compound of Formula IV, wherein R₅ is H and R₆ is a C₁-C₄ alkyl group and a compound of Formula II, wherein R₃ is a C₁-C₆ alkyl, and the surfactants comprises at least one polyoxyalkylene fatty alcohol ether and an anionic and nonionic surfactant blend.

19. The emulsifiable concentrate of claim 8, wherein the solvents comprises a compound of Formula IV, wherein R₅ is H and R₆ is a C₁-C₄ alkyl group and a C₂-C₁₂ straight-chain or branched-chain alcohol, and the surfactants comprises at least one polyoxyalkylene fatty alcohol ether and an anionic and nonionic surfactant blend.

20. The emulsifiable concentrate of claim 8, wherein the solvents comprises a compound of Formula IV, wherein R₅ is H and R₆ is a C₁-C₄ alkyl group and an aliphatic C₁-C₁₈ alkyl lactate linear or branched in the form of D- and or L-lactate, and the surfactants comprises at least one polyoxyalkylene fatty alcohol ether and an anionic and nonionic surfactant blend.

21. The emulsifiable concentrate of claim 8, wherein the solvents comprises a compound of Formula IV, wherein R₅ is H and R₆ is a C₁-C₄ alkyl group and an aliphatic C₁-C₁₈ alkyl lactate linear or branched in the form of D- and or L-lactate, and the surfactants comprises at least one polyoxyalkylene fatty alcohol ether and an alkyl sodium sulfosuccinate.

22. The emulsifiable concentrate of claim 8, wherein the solvent comprises a compound of Formula IV, wherein R₅ is H and R₆ is a C₁-C₄ alkyl group, and the surfactants comprises at least one polyoxyalkylene fatty alcohol ether, an alkyl sodium sulfosuccinate and a tributylphenol ethoxylate.

23. The emulsifiable concentrate of claim 1 further comprising a co-solvent.

24. The emulsifiable concentrate of claim 1, wherein the emulsifiable concentrate has a viscosity less than 6.7 pascal-second (Pa·s) at a temperature of −5° C.

25. The emulsifiable concentrate of claim 24, wherein the emulsifiable concentrate has a viscosity less than 5 Pa·s at a temperature of −5° C.

26. The emulsifiable concentrate of claim 25, wherein the emulsifiable concentrate has a viscosity less than 4 Pa·s at a temperature of −5° C.

27. The emulsifiable concentrate of claim 26, wherein the emulsifiable concentrate has a viscosity less than 3 Pa·s at a temperature of −5° C.
